(19) United States
(12) Patent Application Publication
(10) Pub. No.: US 2025/0228170 A1
(43) Pub. Date: Jul. 17, 2025

(54) Box Transfer Apparatus and Stem Gripper for Automated Harvesting Systems

(71) Applicant: Mycionics Inc., Putnam (CA)

(72) Inventors: Stefan GLIBETIC, London (CA); Caitlin IDZIAK, Kitchener (CA); Matthew Arno BERTUZZI, London (CA)

(73) Assignee: Mycionics Inc., Putnam (CA)

(21) Appl. No.: 19/172,125

(22) Filed: Apr. 7, 2025

Related U.S. Application Data
(63) Continuation of application No. PCT/CA2023/051341, filed on Oct. 11, 2023.
(60) Provisional application No. 63/379,218, filed on Oct. 12, 2022.

(51) Int. Cl. A01G 18/70; A01G 18/64; B25J 15/02

(52) U.S. Cl. CPC A01G 18/70; A01G 18/64; B25J 15/024

(57) ABSTRACT

A box transfer apparatus for an automated harvesting system is provided, the box transfer apparatus comprising: a frame; a plurality of trays to support a plurality of boxes; and a box gripper moveable within the frame using a gantry coupled to the frame; wherein the box gripper is configured to grasp boxes and move the grasped boxes between the frame and an adjacent frame used to convey the boxes to be used in receiving picked items from the automated harvesting system. A stem gripper for an automated harvesting system is also provided, the stem gripper comprising: a housing comprising at least one motor; a pair of contoured fingers operable by the at least one motor to rotate above a common axis to grasp stems of items picked by the automated harvesting system; and a drive mechanism to move the stem gripper from a discard bin to a box for loading.

### CROSS-REFERENCE TO RELATED APPLICATION(S)

This application is a Continuation of PCT Application No. PCT/CA2023/051341 filed Oct. 11, 2023, and claims the benefit of priority to U.S. Provisional Patent Application No. 63/379,218 filed on Oct. 12, 2022, the entire contents of which are incorporated herein by reference in their entirety.

### TECHNICAL FIELD

The following generally relates to systems, methods, and apparatus for harvesting and packing mushrooms or other growing materials in a growing bed and, more particularly to a box transfer apparatus and stem gripper for same.

### BACKGROUND

The cultivation of Agaricus bisporus (i.e., mushrooms) is an intricate process that requires careful preparation of a substrate in multiple stages and the maintenance of precise environmental conditions during the growth and fruiting. The substrate (i.e., growing medium) used for cultivation is nutritious compost prepared in a special manner with a layer of casing at the top. The casing material should not have any nutrients and should possess good water holding capacity with a texture permitting good aeration and neutral pH level, which causes complex surface and large variation of its height. The casing soil needs to be layered on top of the compost infiltrated with mycelia. Harvesting is to be performed after every flush of growth, approximately every 7 to 10 days. Harvesting is required to be intensive yet accurate, since mushrooms approximately double their size and weight every 24 hours but do not become ripe at the same time. After reaching maturity, the mushroom needs to be quickly picked before the bottom of the mushroom's cap opens. Most of the crop might be harvested within the first two flushes from a single load of bed. One load might give up to four flushes. The growing beds then have to be emptied and sterilized, to kill pests, infections and molds.

Agaricus bisporus is usually grown in multilayer shelving growing bed system for efficient utilization of a farm space and for maximizing yields. This infrastructure allows reaching mushrooms on the whole surface from the sides of the bed by human pickers. The Dutch-type shelving was not designed to accommodate machinery within its boundaries. The beds used for growing mushrooms in the North American region (i.e., in approx. 90% of farms) are more or less standard. Usually, there are only about 16 centimeters of space between mushroom caps and the ceiling of the shelves that can be used for any picking apparatus should one be contemplated.

Currently, mushrooms intended for the fresh market are harvested by hand.

Although the standard grow bed system is suitable for manual harvesting, as previously stated, such systems leave little room for the introduction of automated methods of mushroom harvesting without modifying the infrastructure of the farm or the process of cultivation. For example, the limited vertical space between the stacked grow beds does not allow for the use of standard harvesting systems due to their large size and lack of portability. Additionally, the limited space creates difficulty for standard camera imaging systems as they can only see small portions of the growing bed or suffer from distortions and mushroom occlusions if oriented towards the bed at an angle. Furthermore, mushrooms and their growing environments experience highly dynamic properties while growing (e.g., varying ambient light sources, mushroom color, shape, size, orientation, texture, neighborhood density, and rapid growth rate). The variation of these properties creates difficulties for consistent and precise detection of mushroom properties via optical image processing algorithms.

A mushroom grows at an accelerated rate in a controlled growing room environment. In order to increase the yield a grower will introduce a growth stagger which achieves multiple waves of mushroom growth within the same square meter of growing space. Selective harvesting is the process of harvesting a specific mushroom at the optimal size to maximize crop yield. Neighboring mushrooms also have an effect on the mushrooms around them so the selective harvesting process can be complex. Selective harvesting also includes the identification and harvesting of a smaller sized mushroom in order to provide room for adjacent, larger mushroom to grow to maximize size.

Depending on the commercial mushroom farm operation manual (human) harvesters are instructed to pass over the mushroom beds multiple times throughout the day to try and achieve the theory of selective harvesting. Manual harvesting is unable to achieve true selective harvesting because of difficulties in accurately measuring the diameter of a mushroom with your eyes, differences in a harvester training retention and a harvester's experience all which results in variation in the harvest results and reduction to crop yield. Further, manual harvesting is typically conducted during a single 8-10 hour shift which can result in mushroom harvested at the end of the shift being picked before they are at an optimal size. If a mushroom is not picked at the end of the shift the growth overnight could cause the mushrooms to exceed the target size and the resulting product becomes waste (e.g., an open mushroom that is too small).

FIG. 1 is a photograph of the front view of a single level or shelf of a typical Dutch-style multilayered grow bed. The photograph clearly shows mushrooms at different stages of development, mushrooms growing in groups (often referred to a “clusters”), mushrooms growing upright, mushrooms grown sideways, and so forth.

Attempts have been made to automate the harvesting (picking) of a mushroom but are still challenged by the following: 1) damage (bruising) to the mushroom by the picking devices, and 2) the requirement to transport the growing medium including mushroom(s) to the picking device.

Mushrooms are a very delicate produce and using vacuums and/or suction cups to detach a mushroom from the substrate will most likely cause damage to that mushroom making it non-saleable. Sometimes the damage on the mushroom is not noticeable initially but while sitting in the cooler (e.g., within 24 hours) bruising will become more evident. The issue with transporting the growing medium to the harvester is that it requires a lot of energy and it disturbs the growing environment of the mushrooms. A mushroom growing room has been specifically designed to create an evaporative environment for the ideal mushroom growing environment through the controlling of air flow, humidity, and temperature. That is, by removing the mushrooms and growing medium from this environment you are adversely affecting the growing of mushrooms.

There remains a need for fully automated methods and systems for harvesting a single mushroom and multiple mushrooms from a mushroom bed or stacked mushroom beds, which reduces damage to mushroom caps, maximizes yield through selective harvesting, and are able to support pre-existing growing room infrastructure and conditions.

### SUMMARY

The following provides a system, method, and apparatus for autonomous, semi-autonomous and manual harvesting and packing of mushrooms that addresses the above challenges and can enable an industrial standard of mushroom harvesting while adapting to and leveraging the existing infrastructure to avoid large modification costs. In particular, the following describes a box transfer apparatus and stem gripper for same.

In one aspect, there is provided a system for handling items obtained by an automated harvesting system, the system comprising: a stem gripper comprising: a housing comprising at least one motor; a pair of contoured fingers operable by the at least one motor to rotate about a common axis to grasp stems of items picked by the automated harvesting system; a controller to operate the fingers to reposition grasped items along the stems in response to at least one feedback signal; and a drive mechanism to move the stem gripper from a discard bin to a box for loading.

In certain example embodiments, the at least one feedback signal comprises an estimated stem diameter determined based on a position of the pair of contoured fingers while grasping the stem, and wherein the controller is operable to oscillate the fingers within a range of the estimated stem diameter to settle a cap portion of the item on the fingers to expose additional stem length below the fingers to facilitate a stem cutting operation.

In certain example embodiments, the at least one feedback signal comprises a load detected upon the fingers grasping the stem to detect when a handoff can occur between the stem gripper and the automated harvesting system.

In certain example embodiments, the controller provides a signal to a picker of the automated harvesting system to release the item based on a pre-set load being detected.

In certain example embodiments, the system further comprises a stem cutter in a fixed position to permit the stem gripper to pass a stem through a cutter blade to remove a portion of the stem.

In certain example embodiments, the system further comprises a discard bin located at least partially beneath the stem cutter to receive the portion of the stem removed by the cutter.

In certain example embodiments, the system further comprises the box used to receive the item after the portion of the stem has been removed.

In certain example embodiments, the controller is operable to pivot the fingers to position the item over a drop area in the box.

In certain example embodiments, if the at least one feedback signal detects that the item does not include a stem, the stem gripper is instructed to bypass the discard bin to directly transfer the item to the box.

In another aspect, there is provided a box transfer apparatus for an automated harvesting system, the box transfer apparatus comprising: a frame; a plurality of trays to support a plurality of boxes; and a box gripper moveable within the frame using a gantry coupled to the frame; wherein the box gripper is configured to grasp boxes and move the grasped boxes between the frame and an adjacent frame used to convey the boxes to be used in receiving picked items from the automated harvesting system.

In certain example embodiments, the plurality of boxes and the plurality of trays comprise complementary posts and sockets to secure the box atop the tray.

In certain example embodiments, the box gripper comprises a clamping mechanism to grasp each box using the complementary posts and sockets.

In certain example embodiments, the frame supports a gantry operable to index the plurality of trays upwardly towards a position in a bed wherein the automated harvesting system is operating.

In certain example embodiments, the frame is coupled to a transfer frame that receives the boxes for filling by the automated harvesting system.

In another aspect, there is provided a system as set forth above, and further comprising the box transfer apparatus set forth above, and at least one box.

### BRIEF DESCRIPTION OF THE DRAWINGS

Embodiments will now be described with reference to the appended drawings wherein:

FIG. 1 is a is a photograph of an end view of a single level of a multilayered growing bed.

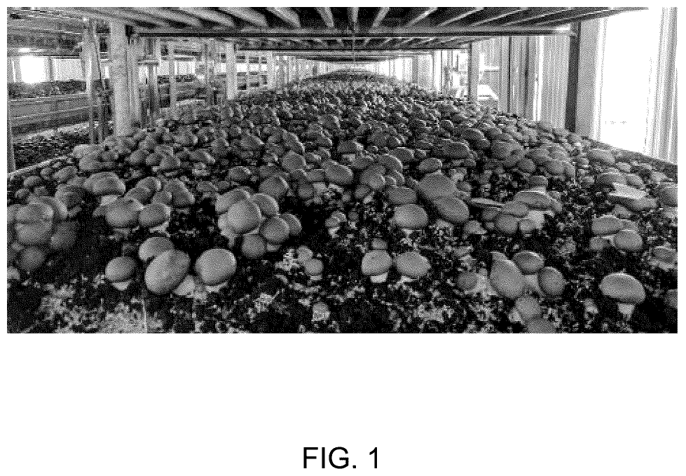

FIG. 2 is a perspective view of a multilayered growing bed with an automated harvesting and packing system deployed thereon.

FIG. 3 is an elevation view of a box transfer apparatus coupled to a transfer frame that together provide an automated packer.

FIG. 4 is a perspective view of the box transfer apparatus in isolation.

FIG. 5 is a perspective view of a box used with the automated packer.

FIG. 6 is a perspective view of a box transfer apparatus loaded with a set of boxes on corresponding box trays.

FIG. 7 is a perspective view of a box tray.

FIG. 8 is a partial elevation view of a portion of the box transfer apparatus.

FIGS. 9 and 10 illustrate a box gripper engaging a box loaded on a box tray in the box transfer apparatus.

FIGS. 11 and 12 are a perspective view and an elevation view respectively, of a box being transferred from the box transfer apparatus into an area in which it can be deposited onto the transfer frame to be transported to an area of the bed being picked.

FIG. 13 is an enlarged partial elevation view illustrating a box being placed onto a scale on the transfer frame.

FIG. 14 is a perspective view of the transfer frame positioned adjacent to an automated harvester to accept and pack picked mushrooms.

FIG. 15 is a perspective view of a stem gripper in isolation.

FIG. 16 is a perspective view illustrating components of the stem gripper.

FIG. 17 is a bottom plan view of the stem gripper illustrating a pair of contoured gripping fingers.

FIGS. 18 to 21 are perspective views of the stem gripper illustrating operation thereof.

FIG. 22 illustrates a stem cutter positioned alongside the stem gripper for removing and discarding a portion of the stem prior to packing the picked mushroom in the box.

FIGS. 23 and 24 illustrate the stem gripper positioned above a box to deposit the mushroom therein by releasing its grip on the mushroom.

FIG. 25 is a flow chart illustrating a set of computer executable operations performed in an example stem gripper feedback loop.

### DETAILED DESCRIPTION

The following provides a box transfer apparatus and stem gripper that can be integrated and used within a system, method(s), and apparatus comprising multiple interacting machines and sub-systems for autonomously/automatically, semi-autonomously/semi-automatically and/or manually harvesting items or other growing material such as mushrooms from a mushroom bed, wherein the yield and quality of the harvest can be improved over standard methods of harvesting. While the examples given below are in the context of mushrooms and mushroom farming, the principles equally apply to any item or growing material in a growing bed, including various materials grown in vertical farming applications.

The system in which the box transfer apparatus and stem gripper can be used, in one implementation, may be referred to herein as a “harvesting and packing system”, having multiple interacting sub-systems, machines or apparatus to transport and position a harvester at different levels of a multi-layered growing bed, operate the harvester to scan and harvest mushrooms from the mushroom beds, and transfer harvested or “picked” mushrooms to a packer having a stem cutter, discard bin(s) and collection bin(s) to enable fully autonomous harvesting and packing.

The harvester sub-system (also referred to as the “harvester” for brevity) can include at least an apparatus/frame/body/structure for supporting and positioning the harvester on a mushroom bed, a vision system for scanning and identifying mushrooms in the mushroom bed, a picking system for harvesting the mushrooms from the bed, and a control system for directing the picking system according to data acquired by the vision system. Various other components, sub-systems, and connected systems may also be integrated into or coupled to the harvester sub-system as discussed in greater detail below.

The vision system as described herein can be implemented in a “rail” or other module integrated into the apparatus of the harvester sub-system to position vision components for scanning and acquiring data of the underlying mushroom bed. The mushroom bed is meant to support a substrate in which mushrooms grow and are to be harvested. The harvester sub-system described herein is configured to move along existing rails of the growing bed, e.g., in a Dutch-style multilayered growing bed to scan and pick periodically and preferably continuously without the need for manual harvesting. The vision system can detect mushrooms, their properties (e.g., position, size, shapes, orientations, growth rates, volumes, mass, stem size, pivot point, maturity, and surrounding space), statistics, and the strategies required for instructing the picking system for autonomous mushroom harvesting.

The rail or module of the vision system can include a precisely machined structure designed to hold one or multiple 3D data acquisition devices or scanners, data routing devices, communication modules, and one or more processing units. Power can be provided by a separate rail or module, herein referred to as a “battery rail”.

The harvester may traverse mushroom growing beds in an automated fashion and may contain mushroom grasping and manipulating technologies (embodied by the picking system), therefore increasing the ability of the overall system to harvest mushrooms of the highest quality and yield within the requirements of industrial production.

The lift sub-system is designed to position and interface the harvester with the growing bed and lift the harvester between all levels of the growing bed with minimal added functionality and infrastructure required. The lift sub-system (also referred to herein as the “lift” or “lift system”) can include a dolly or cart to transport the lift as well as a harvester supported on the lift. The lift attaches to posts of the growing bed and traverses these rails using a combination of swing-arms, rollers, and rack and pinion mechanisms. The lift also used optical sensors to automatically detect each level in the growing bed and can employ a bridging mechanism to permit seamless transfer of a harvester onto a desired level in the growing bed.

The packer sub-system (also referred to herein as the “packer”, “packer system” or “automated packer”) is designed to receive mushrooms from the harvester in a transfer operation, cut the stems of the transferred mushrooms, and pack the mushroom caps (with stems/stem portions removed) into boxes. The automated packer can also incorporate functionality to weigh the boxes as mushrooms are packed and to transfer full boxes away from a transfer zone in place of fresh (empty) boxes.

These various sub-systems or machines interact with each other to provide an end-to-end harvesting system that collects data, semi-autonomously, autonomously, or operator controlled, harvests and packs mushrooms using one or more sets of harvesters, packers and lifts per growing bed, as well as employing a central management server. Using the collected data and the interoperable machines, an optimized harvesting methodology can be employed when compared to traditional manual harvesting techniques.

That is, the sub-systems and machines described herein have the ability to attach to common mushroom growing infrastructure, harvest mushrooms up to 24 h/day, target any desirable mushrooms, and cover the area of the bed sufficiently enough to allow for any target sized mushroom to be harvested (picked, cut, packed and weighed) at any time throughout the harvesting cycle. In addition to harvesting capabilities, the machines have the ability to collect and process compost, mushroom, and growing room condition data. Using the machines' harvesting capabilities, paired with the data collection methodology, the overall harvesting system can thus optimize the desired harvesting parameters and schedules so that mushrooms are always picked at the target size and target time. This data-driven method of harvesting mushroom minimizes common issues which lead to yield reduction, such as harvesting undersized/oversized/low quality mushrooms, and the poor management of harvesting schedules, leading to overharvesting mushrooms, undesirable mushroom stagger, mushroom clustering and premature reproduction cycles.

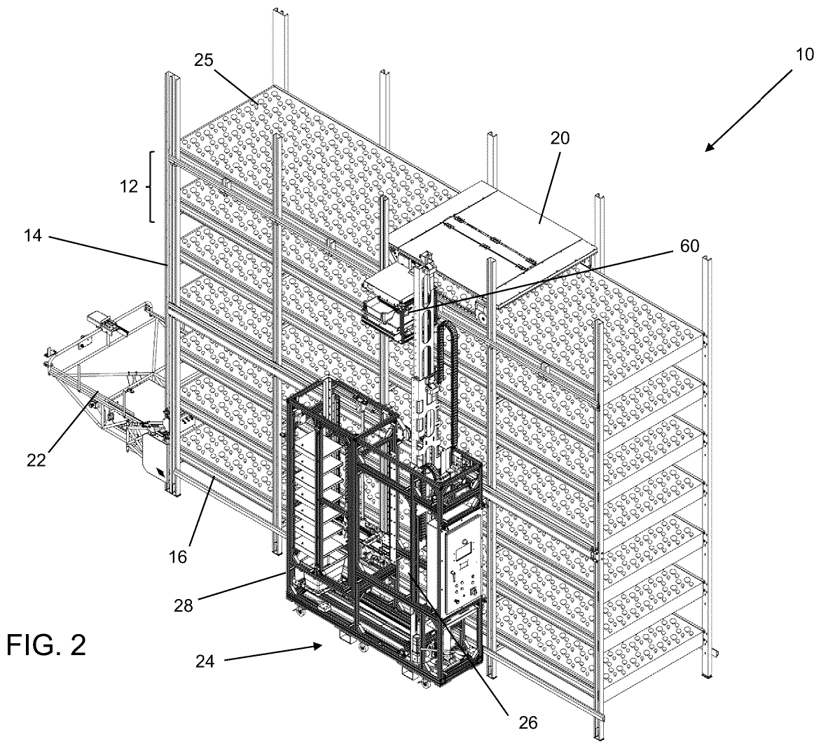

Turning now to the figures, FIG. 2 illustrates an example of a standard (e.g., Dutch-style) multilayered growing bed assembly 10 for, in this example, indoor mushroom growing (or other growing media). It can be appreciated that some components of the growing bed assembly 10 are omitted from FIG. 2 for ease of illustration. The growing bed assembly 10 is constructed to create a plurality of layers or levels 12 (one of which is numbered in FIG. 2). The growing bed assembly 10 includes a number of vertical posts 14 and a pair of side rails 16 at each level 12. The vertical posts 14 and side rails 16 are positioned at a standard distance from each other by a number of cross beams. The cross beams tie the vertical posts 14 together to form each level 12 and support the substrate, i.e., growing medium such as compost. Each cross beam includes a number of square-shaped apertures in this example through which square beams (not shown) can be inserted to support the substrate.

Also shown in FIG. 2 is an automated harvester 20 that is positioned at a particular level 12. As can be appreciated in FIG. 2, the harvester 20 can be positioned at any of the levels 12 and multiple harvesters 20 can be accommodated at any given time, thus illustrating both their mobility and adaptability within the constraints of the standard growing bed assembly 10. A lifter 22 is also shown, coupled to one end of the bed 10 and is currently positioned at one of the levels but can traverse the vertical rails 14 to be positioned at any of the levels 12, e.g., to move one of the harvesters 20 from one level 12 to another. An automated packer 24 is also shown, which is coupled to the bed 10 along one of the side rails 16 such that the automated packer 24 can position itself in aligned with the harvesters 20 as they move along the bed 20. The automated packer 24 includes a mushroom transfer apparatus 26 coupled to a box transfer apparatus 28. The mushroom transfer apparatus 26 is configured to align with and receive mushrooms from the harvester 20, as illustrated in FIG. 2. The mushroom transfer apparatus 26 is also configured to cut and discard stems and place the mushrooms in a box handled by the box transfer apparatus 28 as discussed in greater detail below. The box transfer apparatus 28 is configured to permit both the transfer of mushrooms 25 from the automated harvester 20 to the automated packer 24 and to manage the loading of boxes with such mushrooms 25 as they are filled. As also illustrated in FIG. 2, the mushroom transfer apparatus 26 is telescopic to permit a transfer frame 60 thereof to be positioned in alignment with a desired level 12 of the growing bed 10.

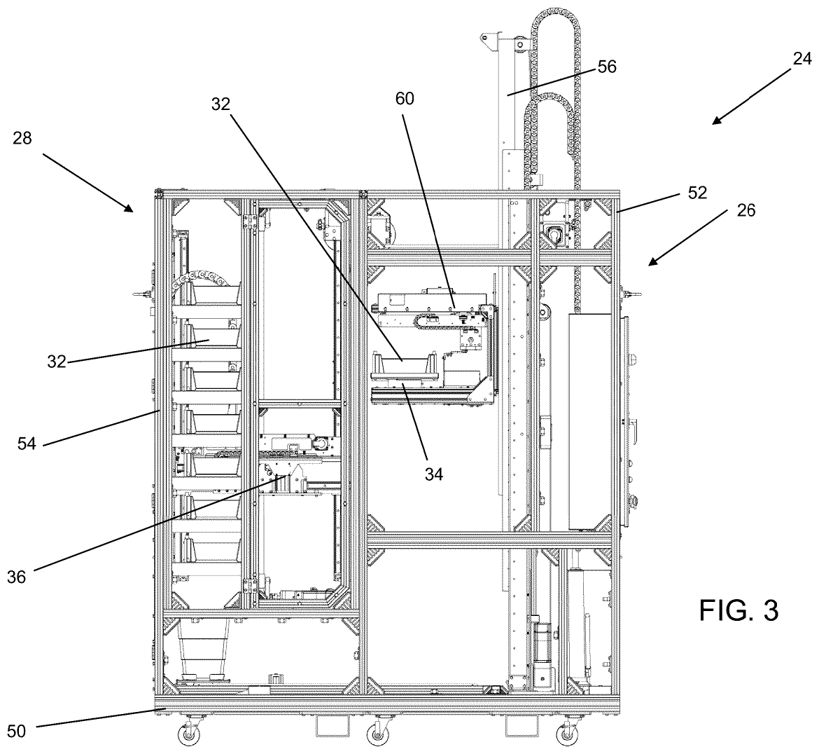

Referring now to FIG. 3, the automated packer 24 is shown in isolation. The packer 24 is designed to serve the purpose of receiving mushrooms 25 from the harvester 20, cutting their stems, and packing them into boxes while being weighed. The packer 24 includes a trolley 50 that is attached to one side or the other of the growing bed 10. In this way, the packer 24 is able to operate (i.e., receive/cut/pack mushrooms 25 transferred from the harvester 20) at any location of the entire bed 10. The trolley 50 includes, or otherwise is coupled to and supports, a first frame 52 for the mushroom transfer apparatus 26, which supports a telescopic arm 56. The telescopic arm 56 is used to elevate the transfer frame 60 to position it adjacent the various levels 12 of the growing bed 10. The trolley 50 also includes, or otherwise is coupled to and supports, a second frame 54 for the box transfer apparatus 28.

The first frame 52 permits the transfer frame 60 to move into and out of a box loading and unloading area, e.g., to unload a full box 32 and to receive an empty box 32 as described below. The second frame 54 permits a box gripper 36 to transfer boxes 32 from stored positions to be placed on a scale 34 in the transfer frame 60. In this way, the box transfer apparatus 28 can interact with the mushroom transfer apparatus 26 to automatically or semi-automatically manage the filling, weighing and retrieval of boxes 32 that have been filled with mushrooms by the harvester 20 and the mushroom transfer apparatus 26. It can be appreciated that the telescopic arm 56 can employ any suitable telescoping mechanism such as the one shown in FIG. 3. This type of telescoping system is used to be able to reach the very top of the bed 10 (level 7), while also being able to reach the very bottom of the bed 10 (level 1). Level 1 is only about 400 mm off the floor.

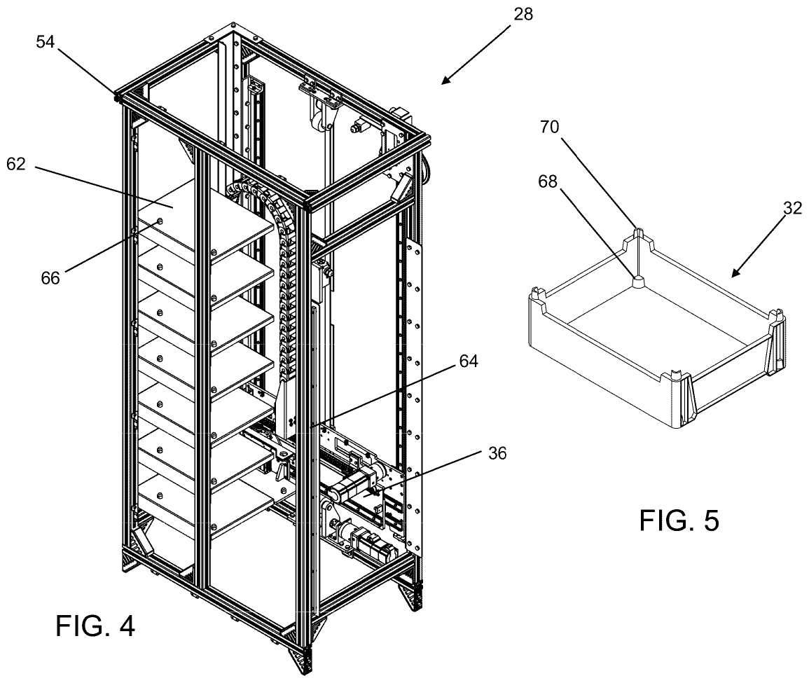

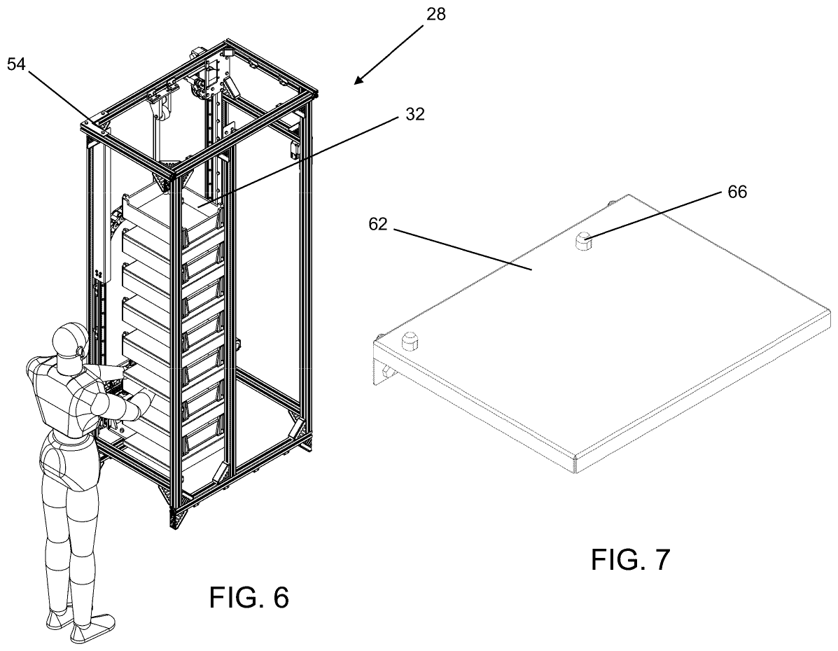

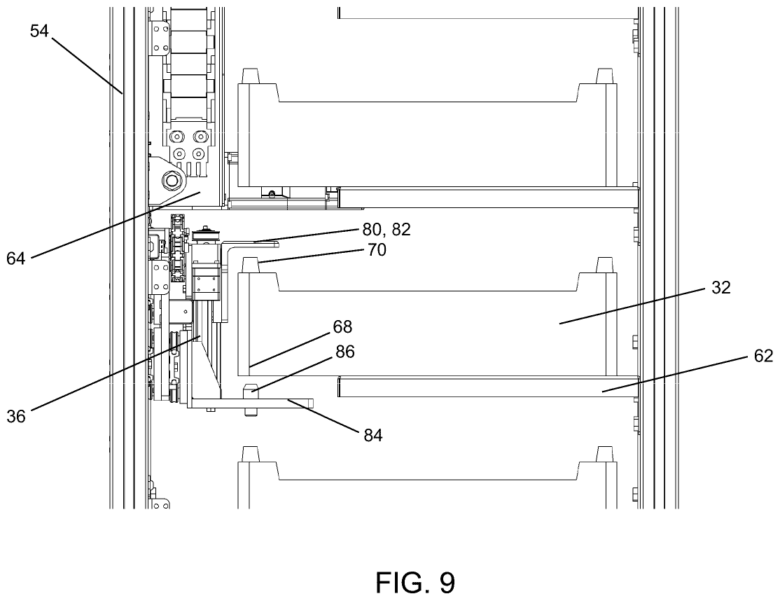

Referring now to FIG. 4, the box transfer apparatus 28 is shown in isolation for ease of illustration. The second frame 54 encloses and protects the mechanisms within the box transfer apparatus 28, including a set of box trays 62, a 2-axis gantry 64, and the box gripper 36 that can be moved within and beyond the extents of the second frame 54 by controlling the 2-axis gantry 64. The box trays 62 are shown in an unloaded state in FIG. 4, which illustrates a pair of locator posts 66 that extend upwardly (see also FIG. 7). Referring also to FIG. 5, these locator posts 66 interact with sockets 68 extending upwardly from the bottom surface of the boxes 32. The sockets 68 are located in the corner portions of the boxes 32 to both interact with the locator posts 66 on the box trays 62 as well as stacking posts 70 extending upwardly from the boxes 32 to permit the boxes 32 to be stacked upon each other, e.g., for transfer, packing, storage, shipment, etc.

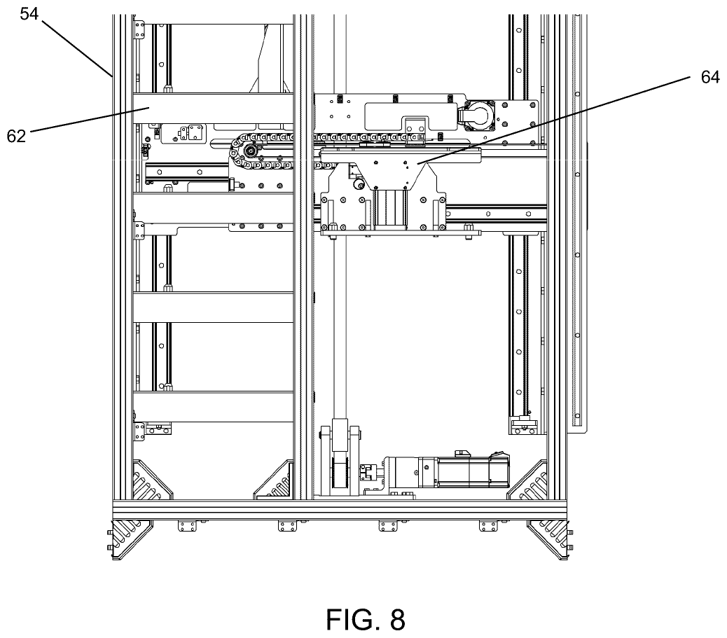

Referring now to FIG. 6, an operator can load empty boxes 32 onto the trays 62 inside the box transfer apparatus 28 to provide a stack of ready boxes to be filled using the harvester 20 and mushroom transfer apparatus 26. The boxes 32 are placed such that the posts 66 align with the sockets 68 to inhibit dislodgement from the apparatus 28. It can be appreciated that while the boxes 32 can be loaded manually as shown, an automated system (not shown) could also be employed.

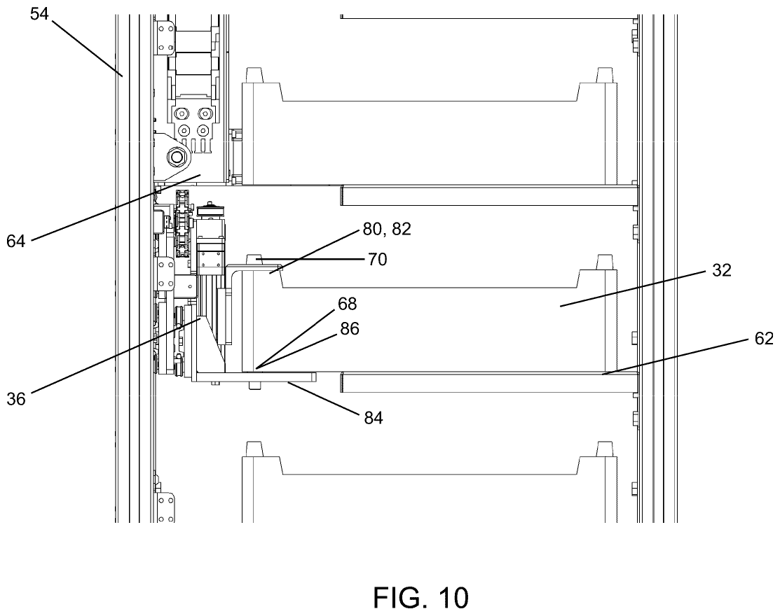

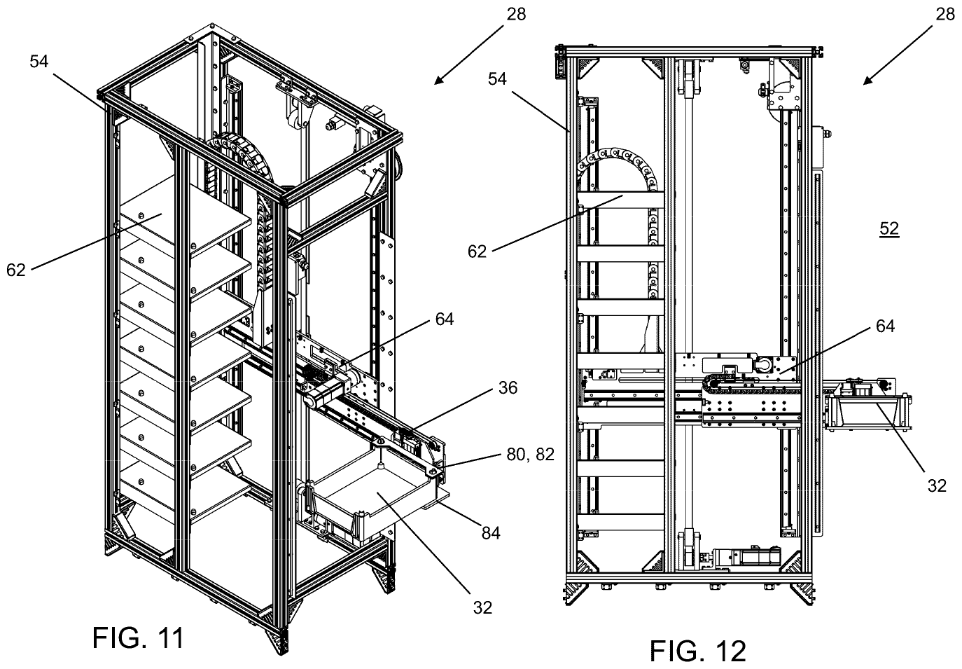

As shown in FIGS. 8 and 9, the gantry 64 moves vertically inside the second frame 54 to retrieve a box 32. FIG. 9 illustrates an enlarged view of the box gripper 36 in an open position. The box gripper 36 includes an upper plate 80 having a hole 82 (not visible) therethrough to permit the plate 80 to grip the upper face of the box 32 by allowing the post 70 to pass through the hole 82. Similarly, the box gripper 36 includes a lower plate 84 with a post 86 that interfaces with a socket 68 in the underside of the box 32 in a manner similar to how the box 32 is supported by the tray 62. FIG. 10 illustrates the box gripper 36 in a closed position in which the box 32 can be lifted off the tray 62 (to clear the posts 66 of the tray 62). It may be noted that this gripping/clamping mechanism can secure the box 32 in the box gripper 36 even when the machine loses power. That is, once clamped, the box 32 is geometrically locked within the box gripper 36, even in the case of no power applied to the clamp motors. It would require a significant amount of force on the box to open the box gripper 36, not normally experienced during routine or intentional operation. Additionally, the box transfer x-y gantry can include fail-safe brakes, such that when power is shut off unintentionally, the brakes will still automatically engage, thus the box gripper 36 would not move away from its position in the case of power failure.

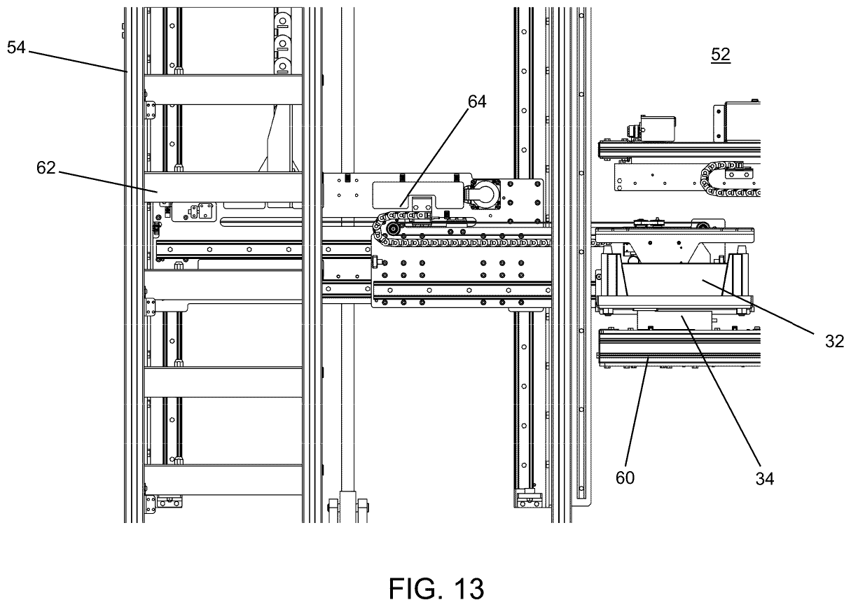

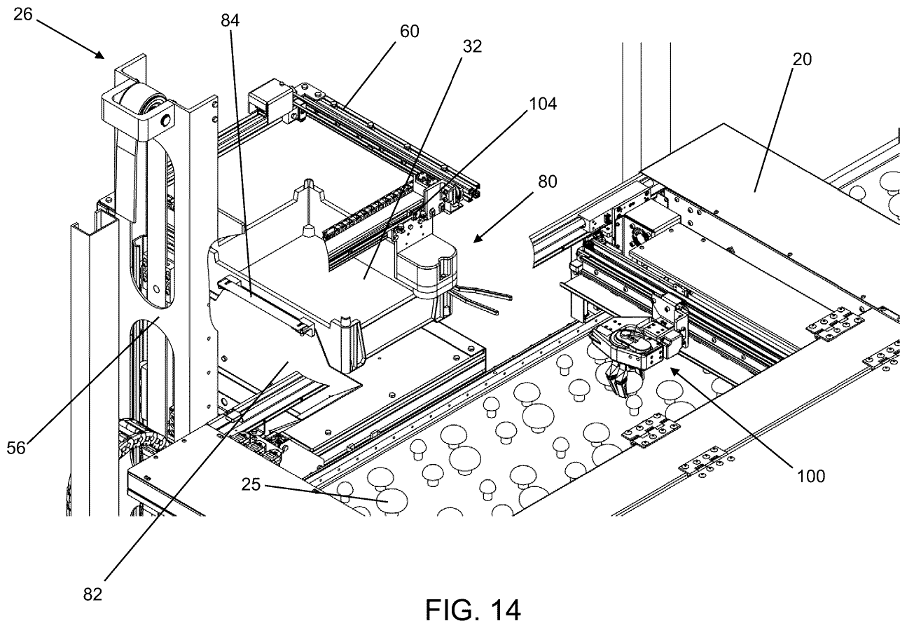

FIGS. 11 and 12 illustrate movement of the gripped/clamped box 32 that has been secured by the box gripper 36 and lifted off the tray 62 can be moved by the gantry 64 through the extent of the second frame 54 and into an area of the first frame 52 (not shown in this figure for ease of illustration). In this way, the gantry 64 can transfer the box 32 into the mushroom transfer apparatus 26 to be used in collecting picked mushrooms by its horizontal axis telescoping to clear the equipment used to move the box 32 between mushroom bed level for filling. This interaction between the box transfer apparatus 28 and the mushroom transfer apparatus 26 is illustrated in FIG. 13, wherein the box 32 is placed on the scale 34 supported by the transfer frame 60 as noted above. The box gripper 36 may then release the box 32 by separating the upper and lower plates 80, 84 and returning the box gripper 36 to within the second frame 54 using the gantry 64. This clears the way for the box 32 to be carried by the transfer frame 60 to the mushroom bed level 12 being picked.

The snapshot in FIG. 13 is also representative of a box retrieval process. That is, when the box 32 has been filled, the gantry 64 can extend its horizontal axis to place the box gripper 36 around the box 32, clamp the box 32 as discussed above, retract the gripped box 32, and place the box 32 back on its original tray 62. The box gripper 36 can then be moved by the gantry 64 to another tray 62 that has an empty box 32 to repeat the process described herein.

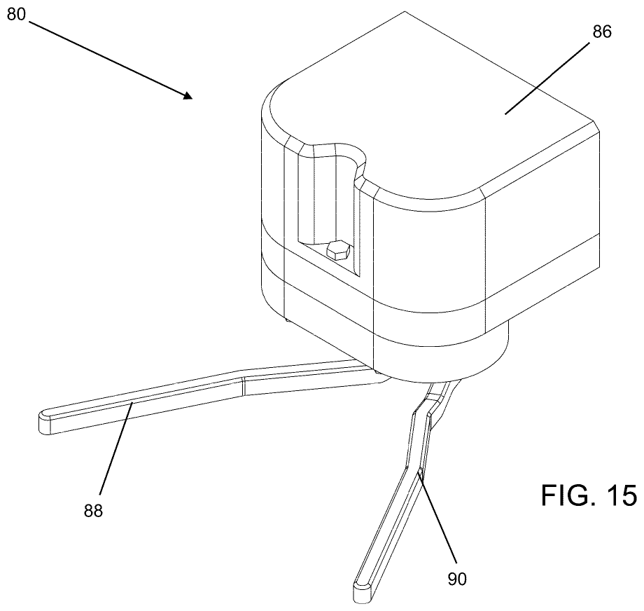

Referring now to FIG. 14, a stem gripper 80 is shown integrated with the transfer frame 60 of the mushroom transfer apparatus 26. In the position shown in FIG. 14, a box 32 is supported within the transfer frame 60 in a position to permit the stem gripper 80 to receive picked mushrooms 25 from a picker 100 operated by the harvester 20, cut the stem of the mushroom 25 to a desired and selectable height using a cutting blade 84, and place the mushroom 25 in the box 32 while discarding the cut portion of the stem in a discard bin 82. As can be appreciated from FIG. 14, the picker 100 operates to locate and pick a desired mushroom 25 and is configured to travel along its own gantry to meet the stem gripper 80, which has been positioned alongside the level 12 of the bed 10 by the transfer frame 60. In this way, the harvester 20 can move on to the next mushroom 25 in a harvesting schedule while the stem gripper 80 can remove the stem, drop the stem in the discard bin 82, and place the mushroom 25 in the box 32 and be ready to receive the next mushroom from the picker 100.

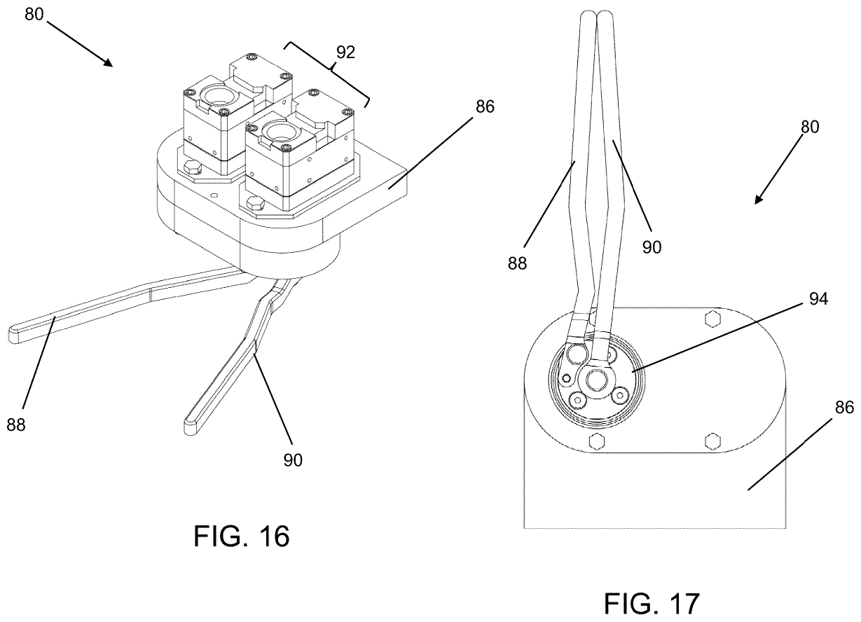

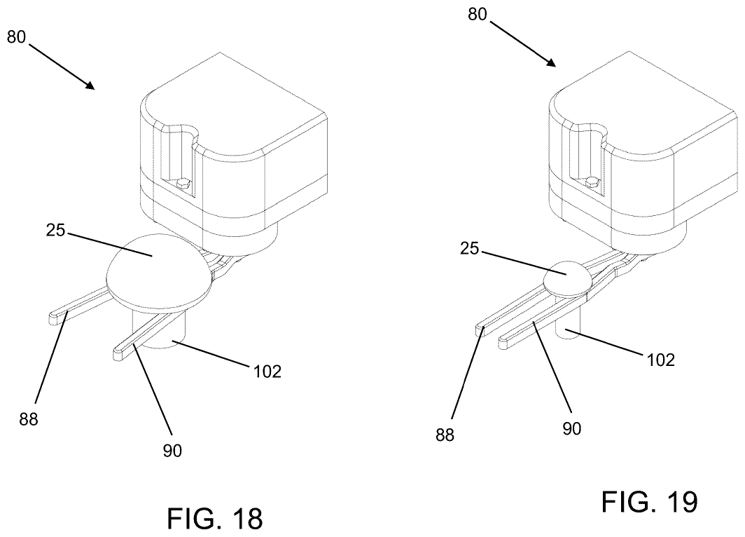

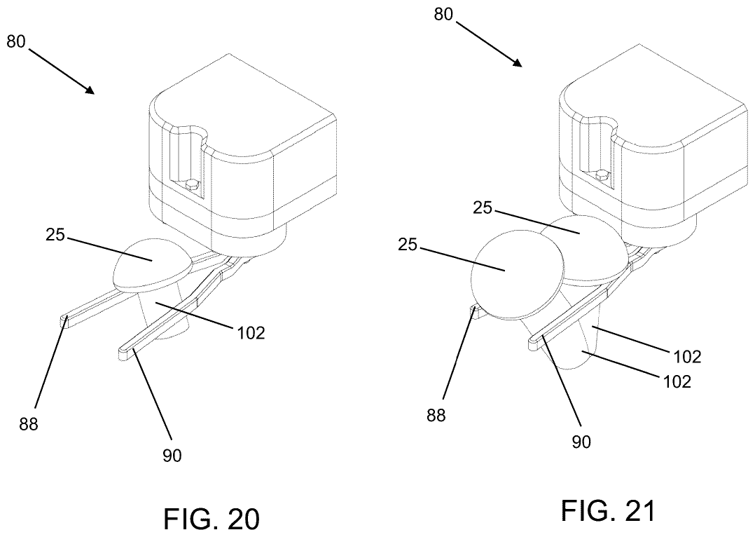

FIG. 15 illustrates the stem gripper 80 in isolation. The stem gripper 80 includes a protective housing 86 that contains a pair of servomotors 92 (see also FIG. 16), a pair of contoured fingers 88, 90, each controlled by a respective servomotor 92, and a drive mechanism 94 (see also FIG. 17) that is controlled by the servomotors 92 to individually control the contoured fingers 88, 90. The drive mechanism 94 between the servo motors 92 and the contoured fingers 88, 90 allows for the servo motors 92 to individually control each finger 88, 90. For example, one finger 88, 90 can be connected to a belt driven pulley to account for the non-axial position of its servo motor 92, and the other finger 88, 90 can be direct-driven since it is already co-axial with its servo motor 92. Referring again to FIG. 15, the stem gripper 80 is positioned by the transfer frame 60 to receive a mushroom 25 and is controlled to open the fingers 88, 90 wide about a common axis in preparation to receive the mushroom 25.

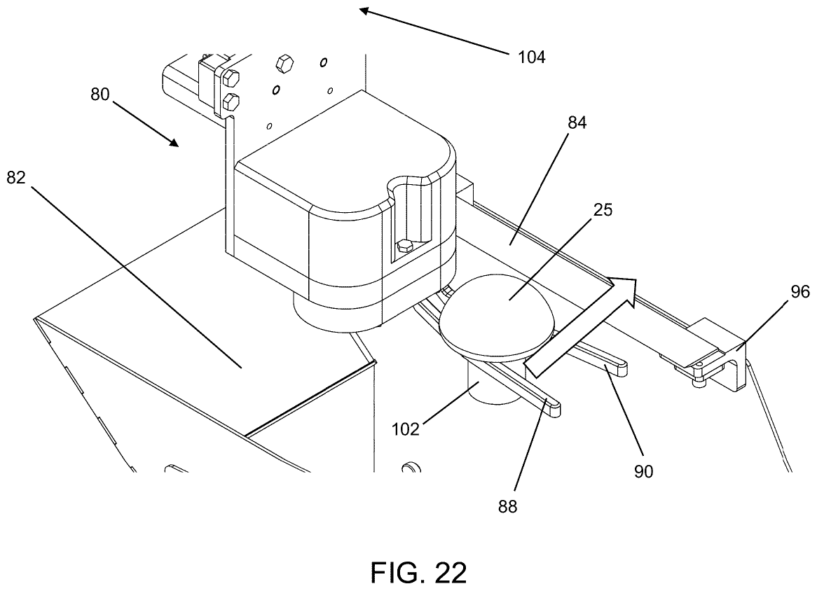

Referring to FIGS. 18-21, the mushroom 25 is automatically presented to the stem gripper 80 via the picker 100. The stem gripper's fingers 88, 90 grasp the mushroom stem 102 gently (until a pre-set load is detected on the servo-motor 92), while the picker 100 releases the mushroom 25. The position and geometry of the gripper fingers 88, 90 in the grasping position allows the stem diameter to be calculated. The gripper fingers 88, 90 rapidly oscillate within the range of the estimated diameter of the stem 102 and the cap of the mushroom 25, to settle the mushroom cap onto the top of the fingers 88, 90 without dropping the mushroom 25. This oscillating motion used in conjunction with the long, slender fingers 88, 90 allows the stem gripper 80 to receive, cut, and pack a variety of mushroom sizes (see FIG. 18 vs. 19) and orientations (see FIG. 20). The stem gripper 80 can also handle clusters of multiple mushrooms 25 (see FIG. 21) and mushrooms 25 that are presented to the stem gripper 80 from a range of heights, and in various positions.

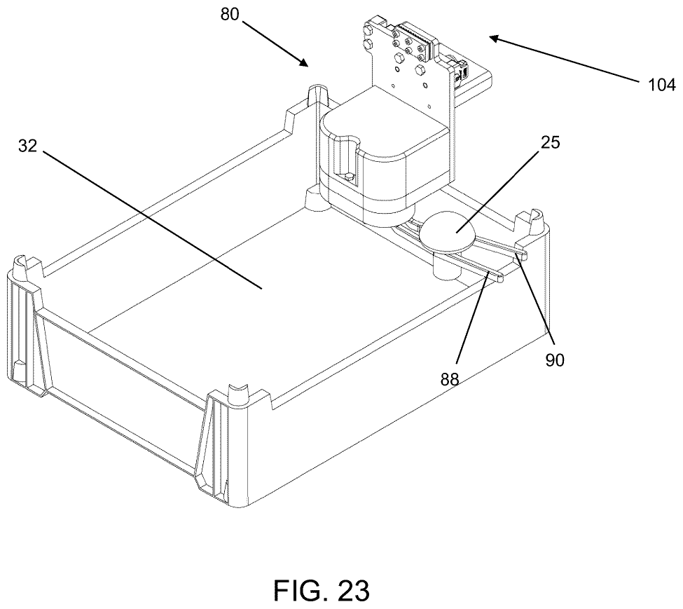

Referring again to FIG. 14 in conjunction with FIG. 22, a 2-axis gantry 104 moves the stem gripper 80 through a height-adjustable blade 84 that is secured to the side of the discard bin 82 using a pair of brackets 96. This movement slices the compost and excess stem 102 off the mushroom 25 and then discarding this excess material by having it drop below into the discard bin 82. The fingers 88, 90 continue clamping on the stem 102 to hold the mushroom 25 in place for a clean cut without causing damage to the mushroom 25. The fingers 88, 90 are held nearly or substantially parallel to the blade 84 to support the stem 102 during the cutting motion to promote this clean cut.

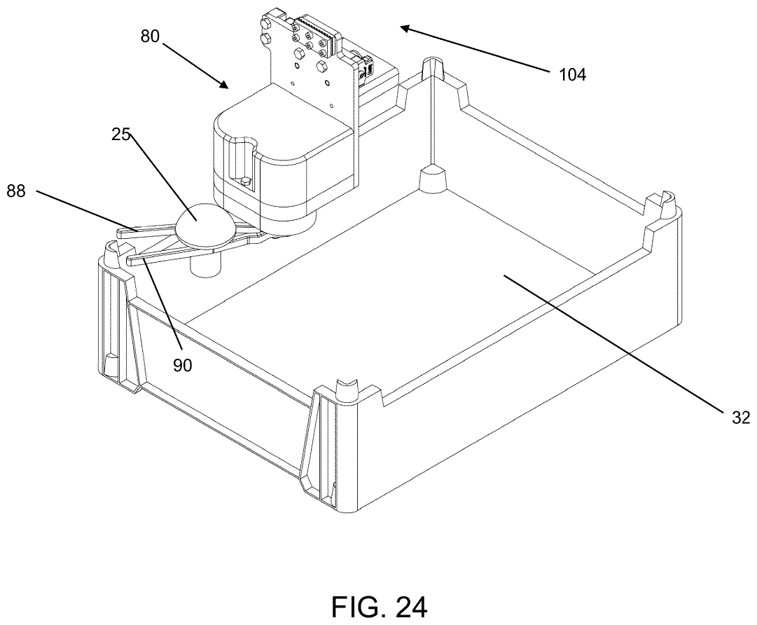

As illustrated in FIGS. 23 and 24, the gantry 104 moves the stem gripper 80 over the mushroom packaging box 32. The fingers 88, 90 pivot to position the mushroom 25 over the drop area (see FIG. 24 vs. FIG. 23). The stem gripper 80 uses this feature to evenly fill the box 32 and can be positioned at various places over the box 32 to promote such even filling. The stem gripper 80 then returns to its ready position (see again FIG. 14) to receive the next mushroom 25.

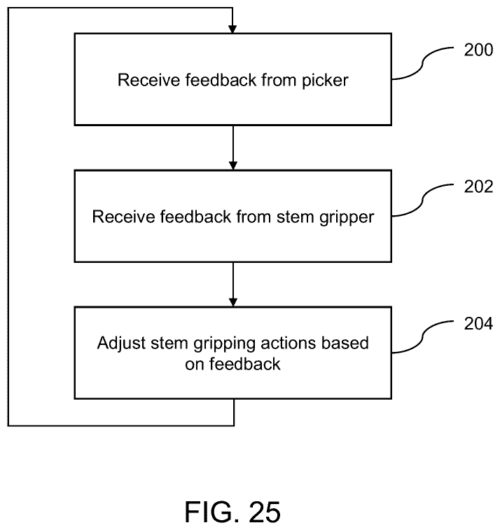

As noted above, the stem gripper 80 can adjust its oscillations and gripping actions based on the nature of the mushroom 25 being picked. Referring to FIG. 25, a feedback loop can be implemented in which feedback signals obtained by the picker 100 can be received at step 200 as well as feedback signals can be obtained by sensing interactions with the contoured fingers 88, 90 of the stem gripper 80 at step 202. For example, the harvester 20, automated packer 24, and a local server (not shown) can communicate during mushroom transfer and adjust the sequence of actions accordingly to the feedback. These feedback signals can be used at step 204 to adjust the stem gripping actions, forces, oscillations, etc. For example, if the stem gripper 80 detects that there is no stem 102, the harvester 20 can be instructed to directly transfer the mushroom to the box 32. Or, if the stem gripper 80 detects that the mushroom stem 102 is larger than the detected mushroom cap, the system can assume that the gripper 80 has grasped a double mushroom 25 instead of a stem 102 and can instruct the picker 100 to lift the mushroom 25 up, and then the stem gripper 80 can grasp the stem 102 again, or can squeeze harder to tear off unwanted mushrooms 25 that came along with the main desired mushroom 25.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the stem gripper 80, harvester 20, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

1. A system for handling items obtained by an automated harvesting system, the system comprising:
a stem gripper comprising:
a housing comprising at least one motor;
a pair of contoured fingers operable by the at least one motor to rotate about a common axis to grasp stems of items picked by the automated harvesting system;
a controller to operate the fingers to reposition grasped items along the stems in response to accepting an item from the automated harvesting system; and
a drive mechanism to move the stem gripper towards a next stage in the system.

2. The system of claim 1, wherein the grasped items are repositioned along the stems in response to at least one feedback signal.

3. The system of claim 1, wherein the stem gripper moves from a discard bin stage to a box for loading.

4. The system of claim 1, wherein the at least one feedback signal comprises an estimated stem diameter determined based on a position of the pair of contoured fingers while grasping the stem, and wherein the controller is operable to oscillate the fingers within a range of the estimated stem diameter to settle a cap portion of the item on the fingers to expose additional stem length below the fingers to facilitate a stem cutting operation.

5. The system of claim 2, wherein the at least one feedback signal comprises a load detected upon the fingers grasping the stem to detect when a handoff can occur between the stem gripper and the automated harvesting system.

6. The system of claim 5, wherein the controller provides a signal to a picker of the automated harvesting system to release the item based on a pre-set load being detected.

7. The system of claim 1, further comprising a stem cutter in a fixed position to permit the stem gripper to pass a stem through a cutter blade to remove a portion of the stem.

8. The system of claim 7, further comprising a discard bin located at least partially beneath the stem cutter to receive the portion of the stem removed by the cutter.

9. The system of claim 8, further comprising the box used to receive the item after the portion of the stem has been removed.

10. The system of claim 9, wherein the controller is operable to pivot the fingers to position the item over a drop area in the box.

11. The system of claim 2, wherein if the at least one feedback signal detects that the item does not include a stem, the stem gripper is instructed to bypass the discard bin to directly transfer the item to the box.

12. A box transfer apparatus for an automated harvesting system, the box transfer apparatus comprising:
a frame;
a plurality of trays to support a plurality of boxes; and
a box gripper moveable within the frame using a gantry coupled to the frame;
wherein the box gripper is configured to grasp boxes and move the grasped boxes between the frame and an adjacent frame used to convey the boxes to be used in receiving picked items from the automated harvesting system.

13. The system of claim 12, wherein the plurality of boxes and the plurality of trays comprise complementary posts and sockets to secure the box atop the tray.

14. The system of claim 13, wherein the box gripper comprises a clamping mechanism to grasp each box using the complementary posts and sockets.

15. The system of claim 12, wherein the frame supports a gantry operable to index the plurality of trays upwardly towards a position in a bed wherein the automated harvesting system is operating.

16. The system of claim 12, wherein the frame is coupled to a transfer frame that receives the boxes for filling by the automated harvesting system.

17. A system for handling items obtained by an automated harvesting system, the system comprising:
a stem gripper comprising:
a housing comprising at least one motor;
a pair of contoured fingers operable by the at least one motor to rotate about a common axis to grasp stems of items picked by the automated harvesting system;
a controller to operate the fingers to reposition grasped items along the stems in response to accepting an item from the automated harvesting system; and
a drive mechanism to move the stem gripper towards a next stage in the system;
a box transfer apparatus for an automated harvesting system, the box transfer apparatus comprising:
a frame;
a plurality of trays to support a plurality of boxes; and
a box gripper moveable within the frame using a gantry coupled to the frame;
wherein the box gripper is configured to grasp boxes and move the grasped boxes between the frame and an adjacent frame used to convey the boxes to be used in receiving picked items from the automated harvesting system; and
at least one box.
